(19) United States
(12) Patent Application Publication
(10) Pub. No.: US 2013/0142094 A1
(43) Pub. Date: Jun. 6, 2013

(54) SYSTEMS AND METHODS FOR FRAME FILTERING AND FOR ENABLING FRAME FILTERING

(71) Applicant: QUALCOMM Incorporated, San Diego, CA (US)

(72) Inventors: Sandip Singh HomChaudhuri, San Diego, CA (US); Santosh Paul Abraham, San Diego, CA (US); Vincent Knowles Jones, IV, Redwood City, CA (US); Simone Merlin, San Diego, CA (US); Zhi Quan, San Diego, CA (US); Sameer Vermani, San Diego, CA (US)

(73) Assignee: QUALCOMM Incorporated, San Diego, CA (US)

(21) Appl. No.: 13/676,421

(22) Filed: Nov. 14, 2012

Related U.S. Application Data
(60) Provisional application No. 61/566,296, filed on Dec. 2, 2011.

(51) Int. Cl. H04W 52/02

(52) U.S. Cl. CPC H04W 52/0206
USPC 370/311

(57) ABSTRACT

The disclosure provides systems, methods, and apparatus for early receive chain shutoff using a typified CRC and/or content change indicator signals. In one aspect, a method for low power frame filtering is provided. The method comprises generating a typified checksum based on a transaction identifier and at least a portion of a packet. The method further comprises transmitting, to at least one receiver, the packet comprising the typified checksum.

### RELATED APPLICATIONS

This application is related to and claims priority from U.S. Provisional Patent Application Ser. No. 61/566,296 filed Dec. 2, 2011, for “SYSTEMS AND METHODS FOR EARLY RX SHUTOFF USING TYPIFIED CRC AND CONTENT CHANGE INDICATOR SIGNALS.”

### FIELD

Certain aspects of the present disclosure generally relate to wireless communications and, more particularly, to a method and apparatus for power savings in wireless systems.

### BACKGROUND

In order to address the issue of increasing bandwidth requirements demanded for wireless communications systems, different schemes are being developed to allow multiple user terminals to communicate with a single access point by sharing the channel resources while achieving high data throughputs. Multiple Input Multiple Output (MIMO) technology represents one such approach that has recently emerged as a popular technique for next generation communication systems. MIMO technology has been adopted in several emerging wireless communications standards such as the Institute of Electrical and Electronics Engineers (IEEE) 802.11 standard. The IEEE 802.11 denotes a set of Wireless Local Area Network (WLAN) air interface standards developed by the IEEE 802.11 committee for short-range communications (e.g., tens of meters to a few hundred meters).

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

In wireless networks with a single Access Point (AP) and multiple user stations (STAs), concurrent transmissions may occur on multiple channels toward different stations, both in the uplink and downlink direction. Many challenges are present in such systems.

### SUMMARY

Various implementations of systems, methods, and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides a method for enabling low power frame filtering. The method comprises generating a typified checksum based on a transaction identifier and at least a portion of a packet. The method further comprises transmitting, to at least one receiver, the packet comprising the typified checksum.

Another aspect of the disclosure provides an apparatus configured to enable low power frame filtering. The apparatus comprises means for generating a typified checksum based on a transaction identifier and at least a portion of a packet. The apparatus further comprises means for transmitting, to at least one receiver, the packet comprising the typified checksum.

Another aspect of the disclosure provides a non-transitory computer-readable medium comprising code that, when executed, causes an apparatus to generate a typified checksum based on a transaction identifier and at least a portion of a packet. The medium further comprises code that, when executed, causes the apparatus to transmit, to at least one receiver, the packet comprising the typified checksum.

Another aspect of the disclosure provides an access point configured to enable low power frame filtering. The access point comprises at least one antenna. The access point further comprises a first circuit configured to generate a typified checksum based on a transaction identifier and at least a portion of a packet. The access point further comprises a transmitter configured to transmit, to at least one receiver via the at least one antenna, the packet comprising the typified checksum.

Another aspect of the disclosure provides a method for low power frame filtering. The method comprises receiving, by a receiver, a packet comprising a typified checksum. The method further comprises generating a second checksum based on a transaction identifier and at least a portion of the packet. The method further comprises comparing the second checksum with the typified checksum. The method further comprises determining that the packet is associated with the receiver if the second checksum matches the typified checksum.

Another aspect of the disclosure provides an apparatus configured for low power frame filtering. The apparatus comprises means for receiving, by a receiver, a packet comprising a typified checksum. The apparatus further comprises means for generating a second checksum based on a transaction identifier and at least a portion of the packet. The apparatus further comprises means for comparing the second checksum with the typified checksum. The apparatus further comprises means for determining that the packet is associated with the receiver if the second checksum matches the typified checksum.

Another aspect of the disclosure provides a non-transitory computer-readable medium comprising code that, when executed, causes an apparatus to receive, by a receiver, a packet comprising a typified checksum. The medium further comprises code that, when executed, causes the apparatus to generate a second checksum based on a transaction identifier and at least a portion of the packet. The medium further comprises code that, when executed, causes the apparatus to compare the second checksum with the typified checksum. The medium further comprises code that, when executed, causes the apparatus to determine that the packet is associated with the receiver if the second checksum matches the typified checksum.

Another aspect of the disclosure provides an apparatus configured for low power frame filtering. The apparatus comprises a receiver configured to receive a packet comprising a typified checksum. The apparatus further comprises a first circuit configured to generate a second checksum based on a transaction identifier and at least a portion of the packet. The apparatus further comprises a second circuit configured to compare the second checksum with the typified checksum and to determine that the packet is associated with the receiver if the second checksum matches the typified checksum.

Another aspect of the disclosure provides a method for enabling low power frame filtering. The method comprises generating a checksum based on a media access control (MAC) header field of a packet. The method further comprises inserting the checksum in the MAC header field. The method further comprises transmitting the packet comprising the MAC header field.

Another aspect of the disclosure provides an apparatus configured to enable low power frame filtering. The apparatus comprises means for generating a checksum based on a media access control (MAC) header field of a packet. The apparatus further comprises means for inserting the checksum in the MAC header field. The apparatus further comprises means for transmitting the packet comprising the MAC header field.

Another aspect of the disclosure provides a non-transitory computer-readable medium comprising code that, when executed, causes an apparatus to generate a checksum based on a media access control (MAC) header field of a packet. The medium further comprises code that, when executed, causes the apparatus to insert the checksum in the MAC header field. The medium further comprises code that, when executed, causes the apparatus to transmit the packet comprising the MAC header field.

Another aspect of the disclosure provides an apparatus configured to enable low power frame filtering. The apparatus comprises at least one antenna. The apparatus further comprises a first circuit configured to generate a checksum based on a media access control (MAC) header field of a packet and configured to insert the checksum in the MAC header field. The apparatus further comprises a transmitter configured to transmit the packet comprising the MAC header field.

Another aspect of the disclosure provides a method for low power frame filtering. The method comprises receiving, by a receiver, a packet comprising a media access control (MAC) header field and a first checksum inserted in the MAC header field. The method further comprises generating a second checksum based on the MAC header field. The method further comprises comparing the second checksum with the first checksum. The method further comprises determining that the packet is associated with the receiver if the second checksum matches the first checksum.

Another aspect of the disclosure provides an apparatus configured for low power frame filtering. The apparatus comprises means for receiving, by a receiver, a packet comprising a media access control (MAC) header field and a first checksum inserted in the MAC header field. The apparatus further comprises means for generating a second checksum based on the MAC header field. The apparatus further comprises means for comparing the second checksum with the first checksum. The apparatus further comprises means for determining that the packet is associated with the receiver if the second checksum matches the first checksum.

Another aspect of the disclosure provides a non-transitory computer-readable medium comprising code that, when executed, causes an apparatus to receive, by a receiver, a packet comprising a media access control (MAC) header field and a first checksum inserted in the MAC header field. The medium further comprises code that, when executed, causes the apparatus to generate a second checksum based on the MAC header field. The medium further comprises code that, when executed, causes the apparatus to compare the second checksum with the first checksum. The medium further comprises code that, when executed, causes the apparatus to determine that the packet is associated with the receiver if the second checksum matches the first checksum.

Another aspect of the disclosure provides an apparatus configured for low power frame filtering. The apparatus comprises a receiver configured to receive a packet comprising a media access control (MAC) header field and a first checksum inserted in the MAC header field. The apparatus further comprises a first circuit configured to generate a second checksum based on the MAC header field. The apparatus further comprises a second circuit configured to compare the second checksum with the first checksum, and configured to determine that the packet is associated with the receiver if the second checksum matches the first checksum.

Another aspect of the disclosure provides a method for low power frame filtering. The method comprises receiving, by a receiver, a packet comprising a media access control (MAC) header field and a first checksum inserted in the MAC header field. The method further comprises generating a second checksum based on the MAC header field. The method further comprises comparing the second checksum with the first checksum. The method further comprises analyzing at least a portion of the MAC header field to determine whether the packet is associated with the receiver if the second checksum matches the first checksum.

Another aspect of the disclosure provides an apparatus configured for low power frame filtering. The apparatus comprises means for receiving, by a receiver, a packet comprising a media access control (MAC) header field and a first checksum inserted in the MAC header field. The apparatus further comprises means for generating a second checksum based on the MAC header field. The apparatus further comprises means for comparing the second checksum with the first checksum. The apparatus further comprises means for analyzing at least a portion of the MAC header field to determine whether the packet is associated with the receiver if the second checksum matches the first checksum.

Another aspect of the disclosure provides a non-transitory computer-readable medium comprising code that, when executed, causes an apparatus to receive, by a receiver, a packet comprising a media access control (MAC) header field and a first checksum inserted in the MAC header field. The medium further comprises code that, when executed, causes the apparatus to generate a second checksum based on the MAC header field. The medium further comprises code that, when executed, causes the apparatus to compare the second checksum with the first checksum. The medium further comprises code that, when executed, causes the apparatus to analyze at least a portion of the MAC header field to determine whether the packet is associated with the receiver if the second checksum matches the first checksum.

Another aspect of the disclosure provides an apparatus configured for low power frame filtering. The apparatus comprises a receiver configured to receive a packet comprising a media access control (MAC) header field and a first checksum inserted in the MAC header field. The apparatus further comprises a first circuit configured to generate a second checksum based on the MAC header field. The apparatus further comprises a second circuit configured to compare the second checksum with the first checksum, and configured to analyze at least a portion of the MAC header field to determine whether the packet is associated with the receiver if the second checksum matches the first checksum

### BRIEF DESCRIPTION OF THE DRAWINGS

FIG. 1 shows an exemplary wireless communication system.

FIG. 2 shows a functional block diagram of an exemplary wireless device that may be employed within the wireless communication system of FIG. 1.

FIG. 3 shows a functional block diagram of an exemplary low power wireless communication system.

FIG. 4 shows a functional block diagram of an exemplary low power communication processor that may be employed within the wireless communication device of FIG. 2.

FIG. 5 illustrates an example structure of a transmission preamble and data of a Physical layer Protocol Data Unit (PPDU) in accordance with certain aspects of the present disclosure.

FIG. 6 illustrates another example structure of a transmission preamble and data of a Physical layer Protocol Data Unit (PPDU) in accordance with certain aspects of the present disclosure.

FIG. 7 illustrates an example structure of a High Throughput Signal (HT-SIG) field in accordance with certain aspects of the present disclosure.

FIG. 8 illustrates an example structure of a Very High Throughput Signal field type A (VHT-SIGA) in accordance with certain aspects of the present disclosure.

FIG. 9 illustrates another example structure of a VHT-SIGA field in accordance with certain aspects of the present disclosure.

FIG. 10 illustrates an example structure of a Very High Throughput Signal field type B (VHT-SIGB) in accordance with certain aspects of the present disclosure.

FIG. 11 illustrates an example structure of a Media Access Control (MAC) layer in accordance with certain aspects of the present disclosure.

FIG. 12 shows another exemplary wireless communication system.

FIG. 13 is a flowchart of an exemplary method for enabling low power frame filtering.

FIG. 14 is a functional block diagram of a wireless device in accordance with an exemplary embodiment of the invention.

FIG. 15 is a flowchart of an exemplary method for low power frame filtering.

FIG. 16 is a functional block diagram of a wireless device in accordance with an exemplary embodiment of the invention.

FIG. 17 is a flowchart of another exemplary method for enabling low power frame filtering.

FIG. 18 is a functional block diagram of a wireless device in accordance with an exemplary embodiment of the invention.

FIG. 19 is a flowchart of another exemplary method for low power frame filtering.

FIG. 20 is a functional block diagram of a wireless device in accordance with an exemplary embodiment of the invention.

FIG. 21 is a flowchart of another exemplary method for low power frame filtering.

FIG. 22 is a functional block diagram of a wireless device in accordance with an exemplary embodiment of the invention.

### DETAILED DESCRIPTION

Various aspects of the novel systems, apparatuses, and methods are described more fully hereinafter with reference to the accompanying drawings. The teachings in this disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method that is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to a different user terminal. A TDMA system may implement GSM or some other standards known in the art. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An OFDM system may implement IEEE 802.11 or some other standards known in the art. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA. An SC-FDMA system may implement 3GPP-LTE (3^{rd} Generation Partnership Project Long Term Evolution) or some other standards known in the art.

The teachings herein may be incorporated into (e.g., implemented within or performed by) a variety of wired or wireless apparatuses (e.g., nodes). In some aspects, a node comprises a wireless node. Such a wireless node may provide, for example, connectivity for or to a network (e.g., a wide area network such as the Internet or a cellular network) via a wired or wireless communication link. In some aspects, a wireless node implemented in accordance with the teachings herein may comprise an access point or an access terminal.

An access point (“AP”) may comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”, Radio Base Station (“RBS”), or some other terminology. In some implementations, an access point may comprise a set top box kiosk, a media center, or any other suitable device that is configured to communicate via a wireless or wired medium. According to certain aspects of the present disclosure, the access point may operate in accordance with the Institute of Electrical and Electronics Engineers (IEEE) 802.11 family of wireless communications standards.

An access terminal (“AT”) may comprise, be implemented as, or known as an access terminal, a subscriber station, a subscriber unit, a mobile station, a remote station, a remote terminal, a user terminal, a user agent, a user device, user equipment, a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), a tablet, an entertainment device (e.g., a music or video device, or a satellite radio), a television display, a flip-cam, a security video camera, a digital video recorder (DVR), a global positioning system device, or any other suitable device that is configured to communicate via a wireless or wired medium. According to certain aspects of the present disclosure, the access terminal may operate in accordance with the IEEE 802.11 family of wireless communications standards.

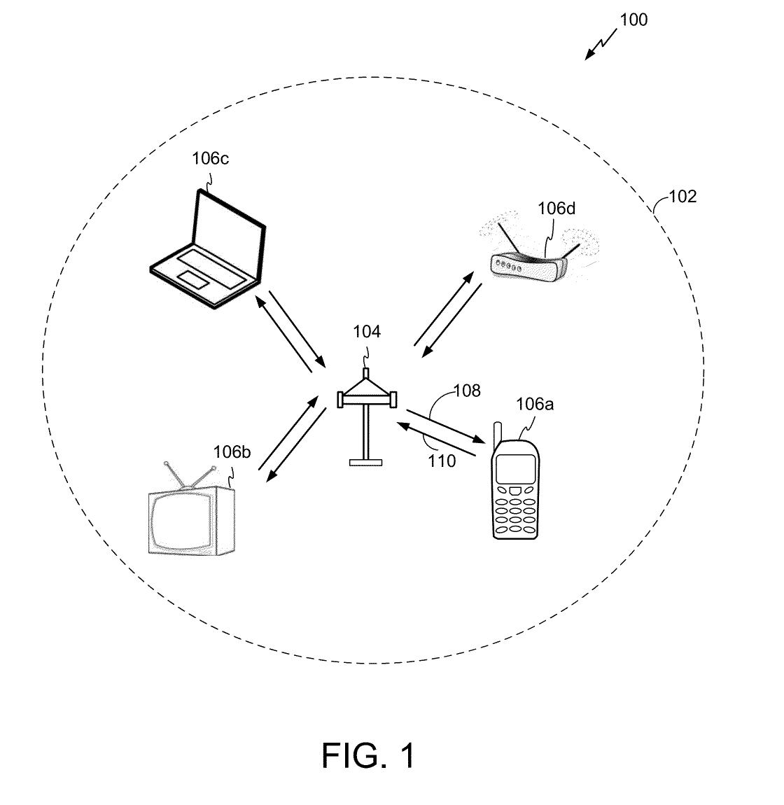

FIG. 1 shows an exemplary wireless communication system. In an embodiment, the wireless communication system 100 may be a multiple-access multiple-input multiple-output (MIMO) system. The wireless communication system 100 may include an AP 104, which communicates with STAs such as a mobile phone 106a, a television 106b, a computer 106c, or another access point 106d (individually or collectively hereinafter identified by 106). For simplicity, only one AP 104 is shown in FIG. 1.

A variety of processes and methods may be used for transmissions in the wireless communication system 100 between the AP 104 and the STAs 106. While portions of the following disclosure will describe STAs 106 capable of communicating via Spatial Division Multiple Access (SDMA), for certain aspects, the STAs 106 may also include some STAs that do not support SDMA. Thus, for such aspects, an AP 104 may be configured to communicate with both SDMA and non-SDMA STAs. This approach may conveniently allow older versions of STAs (“legacy” stations) to remain deployed in an enterprise, extending their useful lifetime, while allowing newer SDMA STAs to be introduced as deemed appropriate.

A communication link that facilitates transmission from the AP 104 to one or more of the STAs 106 may be referred to as a downlink (DL) 108, and a communication link that facilitates transmission from one or more of the STAs 106 to the AP 104 may be referred to as an uplink (UL) 110. Alternatively, a downlink 108 may be referred to as a forward link or a forward channel, and an uplink 110 may be referred to as a reverse link or a reverse channel.

The AP 104 may provide wireless communication coverage in a basic service area (BSA) 102. The AP 104 along with the STAs 106 associated with the AP 104 and that are configured to use the AP 104 for communication may be referred to as a basic service set (BSS). It should be noted that the wireless communication system 100 may not have a central AP 104, but rather may function as a peer-to-peer network between the STAs 106. Accordingly, the functions of the AP 104 described herein may alternatively be performed by one or more of the STAs 106.

The wireless communication system 100 may correspond to the IEEE 802.11ac based wireless communications system. The IEEE 802.11ac represents a new 802.11 amendment that allows for higher throughput in 802.11 wireless networks. The higher throughput may be realized through several measures such as parallel transmissions to multiple user stations (STAs) at once, or by using a wider channel bandwidth (e.g., 80 MHz or 160 MHz). The IEEE 802.11ac is also referred to as Very High Throughput (VHT) wireless communications standard. In other embodiments, the wireless communication system 100 may correspond to the IEEE 802.11ah based wireless communications system.

In VHT wireless networks, it can be advantageous to reduce the power consumed by mobile devices by ensuring that these devices terminate decoding early on packets that are destined for other mobile STAs. One method for ensuring early termination of the decoding process at a receive STA can be to store a destination and possible source identifier within an SIG field of preamble, wherein the preamble may be transmitted from an access point to a plurality of STAs within a packet (frame). A STA of the plurality of STAs may therefore determine if the packet is destined for that STA by simply checking the preamble. However, additional bits required to signal the source and destination may cause high transmission overhead.

Certain aspects of the present disclosure support a low overhead method for signaling the required identifiers by using Cyclic Redundancy Check (CRC) fields that are already present in the SIG field of the preamble.

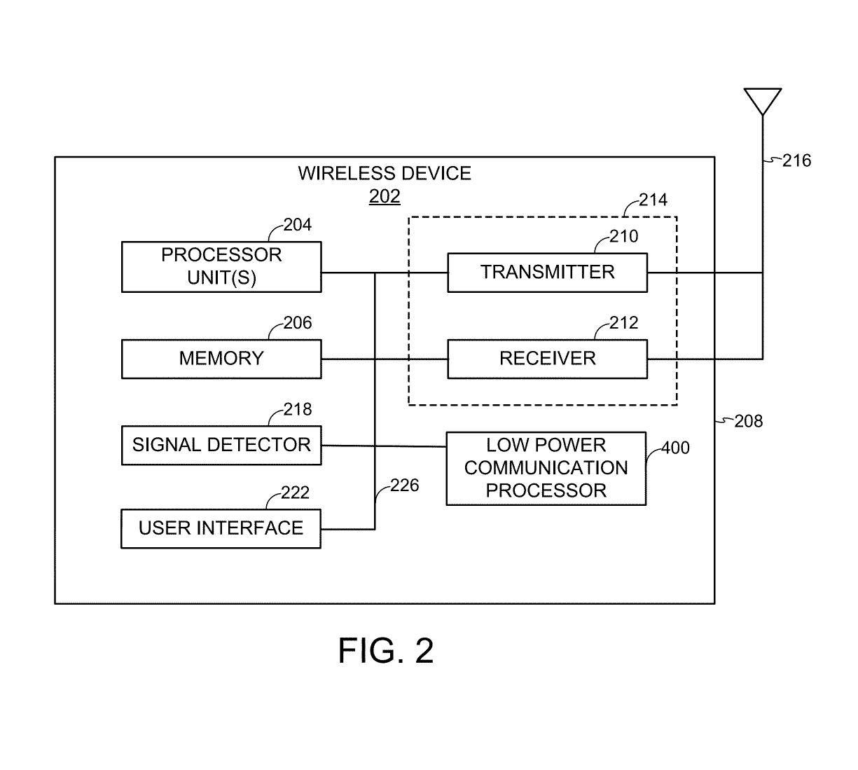

FIG. 2 shows a functional block diagram of an exemplary a wireless device that may be employed within the wireless communication system of FIG. 1. The wireless device 202 is an example of a device that may be configured to implement the various methods described herein. For example, the wireless device 202 may comprise the AP 104 or one of the STAs 106.

The wireless device 202 may include processor unit(s) 204, which control operation of the wireless device 202. One or more of the processor unit(s) 204 may be collectively referred to as a central processing unit (CPU). Memory 206, which may include both read-only memory (ROM) and random access memory (RAM), provides instructions and data to the processor unit(s) 204. A portion of the memory 206 may also include non-volatile random access memory (NVRAM). The processor unit(s) 204 may be configured to perform logical and arithmetic operations based on program instructions stored within the memory 206. The instructions in the memory 206 may be executable to implement the methods described herein.

When the wireless device 202 is implemented or used as a transmitting node, the processor unit(s) 204 may be configured to utilize a low power communication processor 400. The low power communication processor 400 may be configured to generate communications that result in less power being consumed by a receiver node. In some implementations, the low power communication processor 400 may be incorporated in the processor unit(s) 204. The low power communication processor 400 may be configured to generate packets suitable for low power consumption by receivers. Examples including additional functional and structural aspects will be described in further detail below. When the wireless device 202 is implemented or used as a receiving node, the processor unit(s) 204 may be configured to process received packets. If the packets received are identified as packets suitable for low power consumption by receivers, the receiving wireless device 202 may utilize a low power communication processor 400 as part of receiving the packets. In some implementations, the low power communication processor 400 may be incorporated in the processor unit(s) 204.

The processor unit(s) 204 may be implemented with any combination of general-purpose microprocessors, microcontrollers, digital signal processors (DSPs), field programmable gate arrays (FPGAs), programmable logic devices (PLDs), controllers, state machines, gated logic, discrete hardware components, dedicated hardware finite state machines, or any other suitable entities that can perform calculations or other manipulations of information. In an implementation where the processor unit(s) 204 comprise a DSP, the DSP may be configured to generate a packet for transmission. In some aspects, the packet may comprise a physical layer protocol data unit (PPDU).

The wireless device 202 may also include machine-readable media for storing software. The processing unit(s) 204 may comprise one or more machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processor unit(s) 204, cause the wireless device 202 to perform the various functions described herein.

The wireless device 202 may include a transmitter 210 and/or a receiver 212 to allow transmission and reception, respectively, of data between the wireless device 202 and a remote location. The transmitter 210 and receiver 212 may be combined into a transceiver 214. An antenna (or transmit/receive coil) 216 may be attached to the housing 208 and electrically coupled with the transceiver 214. The wireless device 202 may also include (not shown) multiple transmitters, multiple receivers, multiple transceivers, and/or multiple antennas.

The transmitter 210 may be configured to wirelessly transmit packets and/or signals. For example, the transmitter 210 may be configured to transmit different types of packets generated by the processor unit(s) 204 or the low power communication processor 400, discussed above. The packets are made available to the transmitter 210. For example, the processor unit(s) 204 and/or the low power communication processor 400 may store a packet in the memory 206 and the transmitter 210 may be configured to retrieve the packet. Once the transmitter 210 retrieves the packet, the transmitter 210 transmits the packet to a STA 106 wireless device 202 via the antenna 216. The transmitter 210 may be configured to immediately transmit the packet/signals. In some implementations, the transmitter 210 may buffer or queue the packet/signals.

An antenna 216 on a STA 106 wireless device 202 detects the transmitted packets/signals. The STA 106 receiver 212 may be configured to process the detected packets/signals and make them available to the processor unit(s) 204 and/or the low power communication processor 400. For example, the STA 106 receiver 212 may store the packet in memory 206 and the low power communication processor 400 may be configured to retrieve the packet for further processing.

The wireless device 202 may also include a signal detector 218 that may be used in an effort to detect and quantify the level of signals received by the transceiver 214. The signal detector 218 may detect such signals as total energy, energy per subcarrier per symbol, power spectral density, and other signals.

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user. The wireless device 202 may also include a housing 208 surrounding one or more of the components included in the wireless device 202.

The various components of the wireless device 202 may be coupled together by a bus system 226. The bus system 226 may include a data bus, for example, as well as a power bus, a control signal bus, and a status signal bus, in addition to the data bus. Those of skill in the art will appreciate the components of the wireless device 202 may be coupled together or accept or provide inputs to each other using some other mechanism.

Although a number of separate components are illustrated in FIG. 2, those of skill in the art will recognize that one or more of the components may be combined or commonly implemented. For example, the processor unit(s) 204 may be used to implement not only the functionality described above with respect to the processor unit(s) 204, but also to implement the functionality described above with respect to the signal detector 218. Further, each of the components illustrated in FIG. 2 may be implemented using a plurality of separate elements.

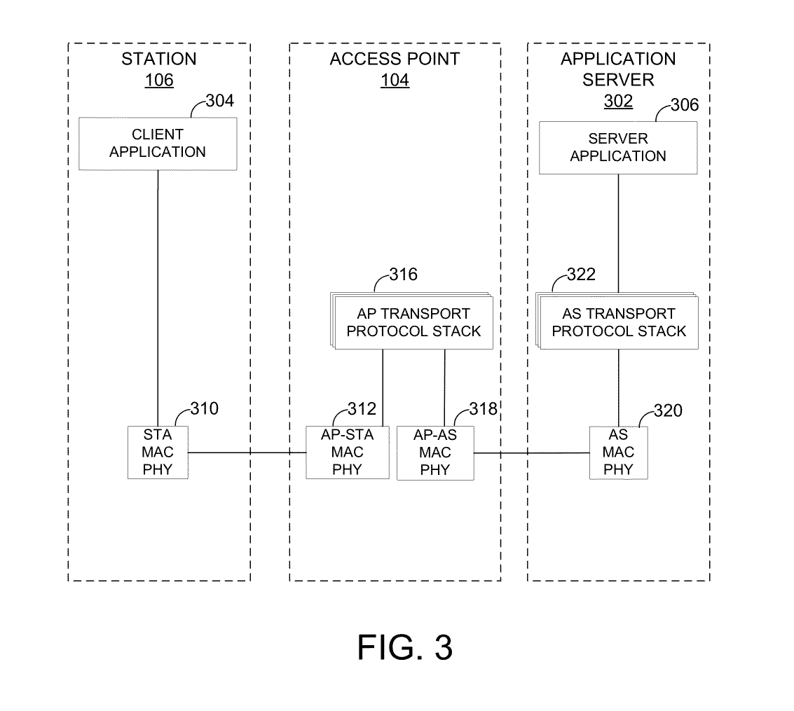

FIG. 3 shows a functional block diagram for an exemplary low power wireless communication system. The system shown in FIG. 3 includes a STA 106, an AP 104, and an application server (AS) 302. In this system, the STA 106 includes a client application 304. For example, the client application 304 may be an Internet web browser. The client application 304 may be configured to access a server application 306 hosted on in the AS 302. In some implementations, the STA 106 may include a transport protocol stack such as TCP/IP (not shown). In such implementations, the client application 304 may be configured to open and maintain the TCP/IP connection. A STA MAC physical link layer 310 (STA MAC PHY), such as an IEEE 802.11 WiFi connection, may be initiated with a corresponding AP-STA MAC PHY 312 included in the AP 104. The AP 104 may then bridge traffic (which may be an IP packet that encapsulates application payload) from the STA 106 to an AP-AS MAC physical link layer 318 (AP-AS MAC PHY), such as Ethernet or WiFi. The AP-AS MAC physical link layer 318 may be coupled with a corresponding AS MAC physical link layer 320 (AS MAC PHY) included in the AS 302.

In an embodiment, the client application 304 may access the AS 302 by generating a connect socket request. The client application 304 or another module (not shown) may convert the socket request into a packet and using the STA MAC PHY 310, transmit the generated packet to the corresponding AP-STA MAC PHY 312 of the AP 104. An AP transport protocol stack 316 may be configured to generate a socket call suitable for transmission via a standard transport protocol (e.g., TCP/IP) based on the generated packet. The details of the packet generation will be described in further detail below.

Once a standard socket call has been generated, an AP transport protocol stack 316 included in the AP 104 may establish a transport link (e.g., TCP/IP) with the AS 302. The AP 104 may then map the transport link to the corresponding AP-STA MAC physical link layer 312. For example, the AP 104 may store, in memory, in a table, the physical MAC address and the associated TCP/IP link setup by the AP 104 on behalf of the STA 106. As described above, the AP-AS MAC PHY 318 is coupled with an AS MAC PHY 320 included in the AS 302. The AS 302 may include a AS transport protocol stack 322 to process and decode the received packets as well as handle related control signaling. Once the AS transport protocol stack 322 has processed the socket call (e.g., combine packets, error detection, decoding), the assembled data is provided to the server application 306. In some implementations, each AP reduced power access network layer will have a corresponding AS transport protocol stack 322.

It will be understood that data originating with the AS 302 destined for the STA 106 may be handled in a similar fashion as just described, albeit in reverse. For instance, some server applications 306 may be configured to “push” messages to a client application 304. The server application 306 may transmit the data through the AS transport protocol stack 322 via the AS MAC PHY 320 to the AP 104. The AP-AS MAC PHY 318 may receive the data. The AP-STA MAC PHY 312 may be configured to process the received data and translate the data into a suitable form to allow the STA 106 and/or other STAs to process the data. In an embodiment, the data may be translated into a form such that a STA may be able to consume less power when analyzing the data to determine whether the received packet should be filtered (i.e., when determining whether the STA is the intended recipient of the data). For example, the AP-STA MAC PHY 312 or another module, like an access network layer, (not shown) may insert a typified cyclic redundancy check (tCRC) and/or a content chance indicator (CCI) signal into a physical link layer of the packet. A tCRC and a CCI signal are described in greater detail below.

Using the AP-STA MAC PHY 312, the packet may be transmitted to the STA 106. In an embodiment, the STA MAC PHY 310 may be configured to receive the packet and provide the packet to the client application 304 or another module (not shown) if it is determined that the data in the packet is intended for the STA 106. The packet, or an assembly of multiple packets, representing the data transmitted by the server application 306 may be ready for use by the client application 304.

In some implementations, the STA 106 may be configured to discover the services provided by other STAs connected to that AP 104. A client application 304 on the STA 106 may be configured to use UPnP or Bonjour as discovery protocols. These protocols may use a multicast IP address to advertise a capability supported by one STA, which are listened to by the other STAs in the system to discover the services supported by other STAs. The STA 106 may be configured to insert a tCRC and/or a CCI signal into a physical link layer of a packet that it broadcasts or multicasts. In some embodiments, the tCRC, CCI signal, and/or other fields of the packet may be used by the listening STAs to determine whether the broadcasted or multicasted packet is intended for or of interest to them. In certain aspects, the tCRC, CCI signal, and/or other fields of the packet may allow listening STAs to use less power in analyzing a received packet.

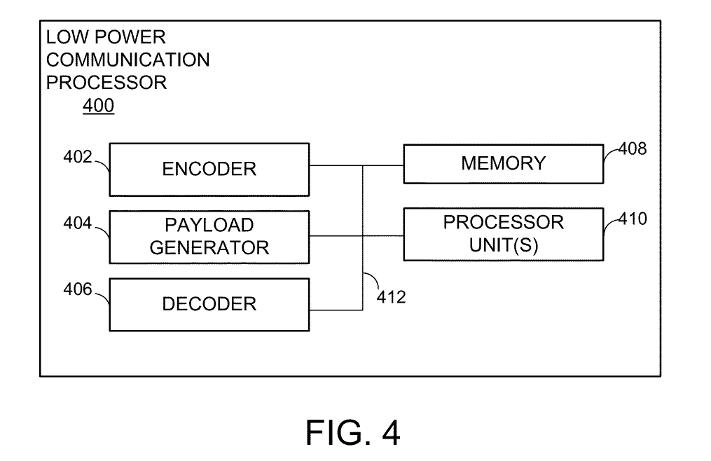

FIG. 4 shows a functional block diagram of an exemplary low power communication processor that may be employed within the wireless communication device of FIG. 2. The low power communication processor 400 may include an encoder 402. In an embodiment, the encoder 402 may be configured to generate a CRC for a packet that is to be transmitted. The CRC may be a tCRC and inserted into a physical link layer of the packet. For example, the tCRC may be inserted in the PPDU of the packet to replace the CRC currently in the CRC field of the PPDU. In this way, low power frame filtering may be achieved without adding additional bits to the PPDU or any other field of a packet or frame. The placement of a tCRC is described in greater detail below.

A tCRC may be an N-bit CRC computed using any known method and scrambled with a transaction identifier. A transaction identifier may be an N-bit station-specific transaction identifier (S-TID) or an N-bit frame-type transaction identifier (F-TID). In some implementations, the transaction identifier may comprise the same number of bits as a CRC to be replaced. In other implementations, the tCRC may be an N-bit CRC computed using any known method and scrambled with more than one transaction identifier. The transaction identifiers together may comprise the same number of bits as a CRC to be replaced. For example, an 8-bit tCRC may be computed using the following equation:

tCRC(D)=(M(D)⊕I(D)⊕x-TID(D))D⁸%G(D)
where x-TID may represent an S-TID or an F-TID, where ⊕ is an exclusive or (XOR) operation, and where a tCRC may also be computed by taking the one's complement of tCRC(D).

In an embodiment, the encoder 402 may generate a tCRC using an S-TID in a directed mode transmission. A directed mode transmission may be a unicast transmission between an AP and a single STA. An S-TID may be N or fewer bits that are associated with a particular STA, where a CRC field of the PPDU may be N bits in length. The S-TIDs may be generated in any way such that no two STAs associated with the AP share the same S-TID. In some implementations, the S-TID may be a function of a partial association identification (partial AID). A partial AID may be used for frame rejection by a STA and located in the PPDU of a packet, such as in protocols like IEEE 802.11ac or IEEE 802.11ah. For example, the S-TID may be the first 8 bits of the partial AID or may be a hash of the partial AID. While an S-TID may be N bits in length, not all 2^{N} possible S-TIDs may be required to address all STAs within the AP's connected set. An N1 number of S-TIDs may be assigned by the AP to address an N1 number of STAs, leaving the remaining 2^{N}−N1 for other purposes. In an embodiment, the remaining 2^{N}−N1 may be F-TIDs. In this way, each STA associated with an AP may have a unique S-TID. If the AP wants to communicate with a particular STA, the encoder 402 may generate a tCRC using the S-TID uniquely associated with the particular STA. Likewise, and as described in more detail below, a decoder 406 in the STA may use the STA's unique S-TID to determine whether a packet is intended for the STA. The STA may be able to make this determination by only decoding a physical link layer of the packet. As is described herein, because the tCRC may replace a CRC present in the PPDU, the STA may be able to make this determination without any additional bits being added to the PPDU.

In an embodiment, the encoder 402 may generate a tCRC using an F-TID in a non-directed mode transmission. A non-directed mode transmission may be a multicast or a broadcast transmission between an AP and one or more STAs. An F-TID may be N or fewer bits that are associated with a type of transmission mode or a type of frame being transmitted, where a CRC field of the PPDU may be N bits in length. In some implementations, the F-TID may be a unicast frame identifier (UFID), a multicast frame identifier (MFID), a broadcast frame identifier (BFID), a wild card identifier (WCID), a traffic indication map (TIM) group 1 identifier (TG1ID), a TIM group 2 identifier (TG2ID), an information element identifier (IEID), or any other type of transmission or type of frame being transmitted that may be relevant to a STA and/or an AP.

A UFID may be used when communicating with a single STA, a BFID and/or an MFID may be used when communicating with several STAs, and a WCID may be defined for use in any desired communication. In some implementations, a TIM is an information element (IE) that may be used to indicate to sleeping STAs whether the AP has any buffered frames present for them. In an embodiment, each bit of a TIM may indicate whether traffic is being held for an associated STA. In another embodiment, the TIM may be formatted as a list of STAs such that the TIM may contain a list of AIDs associated with STAs for which traffic is waiting. A TIM group identifier may be a type of packet or frame that may be used to indicate whether traffic is being held for STAs in a particular group of STAs. Likewise, an IEID may be a type of packet or frame that may be used to indicate a change in an IE of the network. In this way, if the AP wants to communicate with one or more STAs, to communicate with a particular group of STAs, or to indicate a change in an IE, the encoder 402 may generate a tCRC using the appropriate F-TID. Again, as is described in more detail below, a decoder 406 in the STA may use the one or more F-TIDs that the STA is interested in to determine whether a packet is intended for or of interest to the STA. The decoder 406 may use the one or more F-TIDs one at a time in succession or two or more at a same time in making the composite message determination. The STA may be able to make this determination by only decoding a physical link layer of the packet.

In some embodiments, F-TIDs may be less than N bits in length such that two or more F-TIDs may jointly form an N-bit composite. For example, an F-TID representing a first IEID may be N/2 bits in length and an F-TID representing a second IEID may be N/2 bits in length. In some implementations, an STA may be interested in the first IEID only if the AP is also indicating a change in a second IE via the second IEID. An AP may conserve power by having to only transmit a single packet, whereas the STA may also conserve power by only having to decode a portion of a single packet. Since the tCRC may be located in the physical link layer of the packet, the STA may be able to filter the packet without decoding the media access control (MAC) layer of the packet if it finds that the tCRC was generated by scrambling the first IEID, but not the second IEID. In other implementations, an STA may be interested in the first IEID and the second IEID independent of each other. Again, both the AP and the STA may conserve power in the same way as described above. As another example, the encoder 402 may create a tCRC based on a composite x-TID, which may indicate the presence of a TG1ID and an IEID. This tCRC may pass verification if descrambled by a decoder 406 with a composite x-TID containing the TG1ID and the IEID. Note that the N-bit composite may be composed of any combination of F-TIDs. In this way, an AP may provide more information to one or more STAs in a single transmission, allowing the AP and/or STA to conserve power.

In an embodiment, the encoder 402 may be configured to allow for more granular low power filtering for broadcast and/or multicast frames. In some implementations, the encoder 402 may generate a tCRC using at least one F-TID, such as a BFID and/or an MFID, indicating a broadcast and/or multicast packet. In such instances, the encoder 402 may reuse M bits of the physical link layer of the packet in the form of one or more content change indicators (CCIs). A CCI may impart additional management and/or control information about the packet, which may allow for an earlier shutoff of the receive chain of an STA. For example, a CCI may indicate a specific IE present in a beacon, broadcast, and/or multicast packet that a STA typically associates a filter with. As another example, a CCI may indicate a specific IE present in a beacon, broadcast, and/or multicast packet that is of interest to a STA.

In some implementations, the M bits that may be reused may be some or all of the bits allocated to the partial AID. In an embodiment, the partial AID may not be needed because of the use of one or more x-TIDs in generating a tCRC. A 9-bit partial AID, as defined, for example, in IEEE 802.11ac, may be used to indicate various other CCI signals. For example, a 2³ Hadamard Code may be used by the encoder 402 to encode 8 CCIs. This may be implemented with an energy detector after cross-correlation with a software-set IE filter. As another example, a 2⁹ combination of individual change events may be used by the encoder 402 to encode the CCIs. In another example, the encoder 402 may group STAs based on their AID, such as by implementing the following equation: AID_{STA}% N_{groups}, where the remainder of the equation indicates the group of a particular STA. The encoder 402 may generate CCIs to indicate change events relevant to each group.

In other implementations, the M bits that may be reused may be overloaded bits in the PPDU that are irrelevant in multicast and/or broadcast packets or frames. For example, bits associated with a Group ID field, a Modulation and Coding Set (MCS) field, an Advanced Coding field, and/or a Short Guard Interval (Short GI) field may be reused as CCIs.

In this way, an AP may be able to provide additional information to one or more STAs to allow them to determine whether the packet should be filtered. As is described herein, a STA may be able to filter a packet, and thereby conserve energy by not having to decode the entire packet, even if it is initially determined via the tCRC that the packet is intended or of interest to the STA. As may be the case with the tCRC, a STA may be able to perform these functions using a CCI without any additional bits being added to the PPDU or any other field of the packet or frame.

In an embodiment, the encoder 402 may be configured to generate a packet that contains a CRC field in the MAC header of the packet. The CRC may be a tCRC or any CRC that may be computed using any known method. In some implementations, the CRC may be a checksum of the MAC header of the packet. If the CRC passes, then the integrity of the MAC header content may be verified and the STA may be able to compare the fields within the MAC header to achieve filtering. In this way, a CRC of the MAC header may allow an STA to examine the contents of the MAC header without having to first decode the entire packet. A STA may be able to determine whether it is an intended recipient of the packet without having to decode the entire MAC layer. In an embodiment, if the CRC is a tCRC, a STA may be able to filter the packet based on whether the tCRC passes without having to examine the contents of the MAC header and/or without having to first decode the entire packet. The location of the CRC in the MAC header is described in greater detail below.

The low power communication processor 400 may include a payload generator 404. The payload generator 404 may be configured to construct a data payload for transmission based on one or more encoded messages. For example, the payload generator may concatenate multiple messages into a single payload if adequate bandwidth is available for both messages. The payload generator 404 may also compress or otherwise optimize the encoded message. For example, the payload generator 404 may identify a message awaiting transmission (e.g., buffered or queued at the transmitter 210) having an attribute (e.g., operand, parameter) in common with a message currently being processed. In this case, the payload generator 404 may discard the message currently being processed. In some implementations, the function of the payload generator 404 and the encoder 402 may be combined in a single unit.

The low power communication processor 400 may include a decoder 406. The decoder 406 may be configured to decode a packet to determine whether the packet is intended for or of interest to a STA. The decoder 406 may make this determination by descrambling a tCRC located in the packet. In an embodiment, the decoder 406 may generate a STA tCRC using the formula for a tCRC as described above. The decoder 406 may use an S-TID and/or an F-TID depending on the type of packets an STA is interested in or the type of transmission mode used by a STA to communicate with an AP. For example, in a directed mode transmission, the decoder 406 may use an S-TID to generate a STA tCRC. The STA tCRC may be compared to the tCRC located in the packet to determine whether the packet is intended for the particular STA. If the STA tCRC and the tCRC located in the packet match, then the packet may be intended for the particular STA. Packets that are not intended for the particular STA may be filtered. In this way, since the tCRC located in the packet may be located in the physical link layer, the decoder 406 of a STA may only need to decode a physical link layer of the packet in order to determine whether to filter a packet. The STA may be able to conserve energy if it is ultimately determined that the packet is not intended for the STA because the STA may be able to enable early shutoff of the receive chain. Packets that are intended for the particular STA may be further decoded by the decoder 406 and/or other modules of the STA.

As another example, in a non-directed mode transmission, the decoder 406 may use one or more F-TIDs to generate a STA tCRC. The STA tCRC may be compared to the tCRC located in the packet to determine whether the packet is intended for or of interest to the particular STA as described above. In some embodiments, the decoder 406 may use each F-TID of interest to a STA one at a time in generating the STA tCRC until one or more F-TIDs creates a match between the STA tCRC and the tCRC located in the packet. In other embodiments, the decoder 406 may use two or more F-TIDs of interest to a STA at a time in generating the STA tCRC until one or more F-TIDs creates a match between the STA tCRC and the tCRC located in the packet. In this way, since the tCRC located in the packet may be located in the physical link layer, the decoder 406 of a STA may only need to decode a physical link layer of the packet in order to determine whether to filter a packet. The STA may be able to conserve energy if it is ultimately determined that the packet is not intended for or of interest to the STA because the STA may be able to enable early shutoff of the receive chain. Packets that are intended for the particular STA may be further decoded by the decoder 406 and/or other modules of the STA.

In some implementations, the decoder 406 may determine whether the packet is intended or of interest to the STA by analyzing one or more CCIs that may be in the packet. In an embodiment, the decoder 406 may analyze any possible CCIs after first determining that the packet is a multicast and/or broadcast packet. As mentioned herein, the one or more CCIs located in the packet may indicate that a specific IE is present in the beacon, broadcast, and/or multicast packet or frame. The decoder 406 may filter the packet if the specific IE is not of interest to the STA. Likewise, the decoder 406 may continue decoding the packet if the specific IE is of interest to the STA. In this way, the decoder 406 may analyze one or more CCIs to achieve more granular low power filtering.

In an embodiment, the decoder 406 may be configured to descramble a CRC located in the MAC header of a packet. For example, the decoder 406 may generate a STA CRC of the MAC header and compare it to the CRC located in the MAC header of the packet. If the STA CRC and the CRC located in the MAC header match, the decoder 406 may decide that the STA is the intended recipient of the packet. The decoder 406 may continue decoding the rest of the packet. Likewise, if the CRCs do not match, the decoder 406 may decide that the STA is not the intended recipient of the packet and filter the packet. As described herein, this may enable a STA to filter a packet, and thereby conserve energy by shutting off the receive chain early, without having to decode the entire packet.

The low power communication processor 400 may include one or more processor unit(s) 410, which controls operation of the low power communication processor 400. One or more of the processor unit(s) 410 may be collectively referred to as a central processing unit (CPU). Memory 408, which may include both read-only memory (ROM) and random access memory (RAM), provides instructions and data to the processor unit(s) 410. A portion of the memory 408 may also include non-volatile random access memory (NVRAM). The processor unit(s) 410 may be configured to perform logical and arithmetic operations based on program instructions stored within the memory 408. The instructions in the memory 408 may be executable to implement the methods described herein.

Each element of the low power communication processor 400 may be coupled via a bus system 412. The bus system 412 may include a data bus, for example, as well as a power bus, a control signal bus, and a status signal bus in addition to or in place of the data bus. Those of skill in the art will appreciate the components of the low power communication processor 400 may be coupled together or accept or provide inputs to each other using some other mechanism.

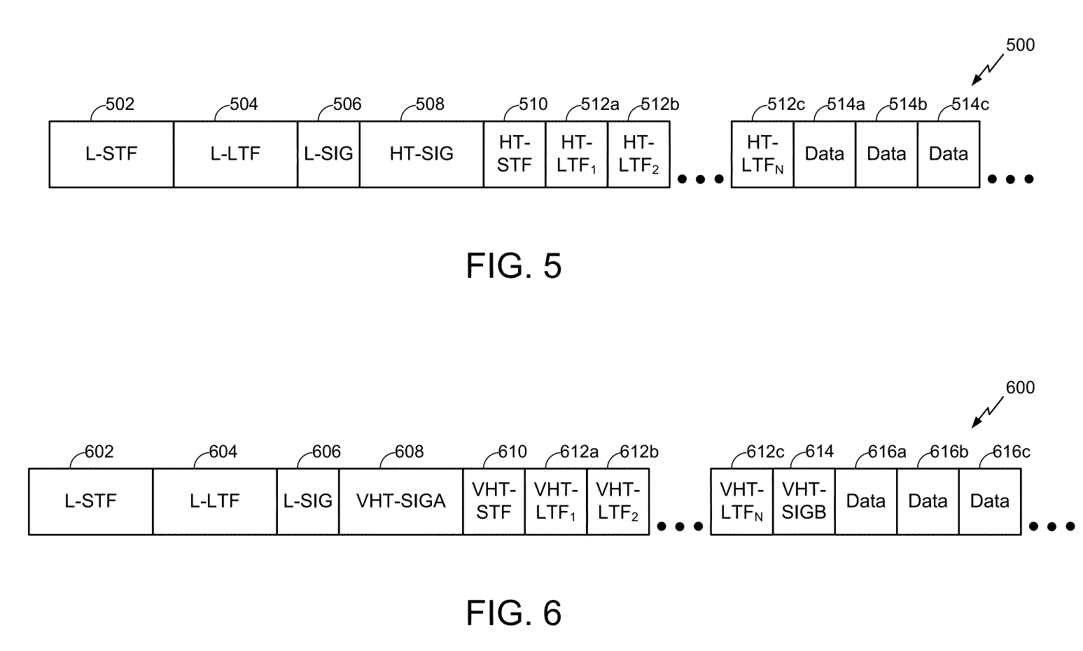

FIG. 5 illustrates an example structure of a frame 500 in accordance with certain aspects of the present disclosure. The frame 500 may be transmitted, for example, from the AP 104 to the STAs 106 in the wireless network 100 illustrated in FIG. 1. Alternatively, the frame 500 may be transmitted from one of the STAs 106 to another STA 106. Transmission of the frame 500 may be performed, for example, in accordance with a radio technology based on IEEE 802.11 family of wireless communication standards. Fields 502 through 512 may be the PPDU of the frame 500.

In Wireless Local Area Networks (WLANs), the process of decoding a packet (e.g., the frame 500) may comprise several steps. A Legacy Short Training Field (L-STF) 502 of the frame 500 may be first received at one or more STAs and used for Automatic Gain Control (AGC) settings. After that, a Legacy Long Training Field (L-LTF) 504 may be received. The reception of L-LTF 504 may ensure that a Legacy Signal field (L-SIG) 506 following the L-LTF 504 may be decoded. The received L-SIG field 506 may provide duration in symbols of the transmitted frame 500.

Following the L-SIG field 506, a High Throughput Signal field (HT-SIG) 508 may be received. This field may provide necessary bits to inform the user STA about the type of data encoded in the frame. In an embodiment, this field may also contain a tCRC, as described herein.

Following the HT-SIG field 508, a High Throughput Short Training Field (HT-STF) 510 may be received. This field may be used to fine-tune receivers in Multi-Input Multi-Output (MIMO) transmissions. After that, one or more High Throughput Long Training Fields (HT-LTFₓ) 512a-c may be received. The reception of the one or more HT-LTFs 512a-c may enable the further tuning of each receiver chain. Following the one or more HT-LTFs 512a-c, Data 514a-c may be received. As described herein, if a tCRC sum of fields 502, 504, 506 and/or 508 does not pass, then the receiving STA may be able to conserve power by not decoding packets that are not intended for it.

FIG. 6 illustrates an example structure of a frame 600 in accordance with certain aspects of the present disclosure. The frame 600 may be transmitted, for example, from the AP 104 to the STAs 106 in the wireless network 100 illustrated in FIG. 1. Alternatively, the frame 600 may be transmitted from one of the STAs 106 to another STA 106. Transmission of the frame 600 may be performed, for example, in accordance with a radio technology based on IEEE 802.11 family of wireless communications standards. Fields 602 through 614 may be the PPDU of the frame 600.

In WLANs, the process of decoding a packet (e.g., the frame 600) may comprise several steps. A Legacy Short Training Field (L-STF) 602 of the frame 600 may be first received at one or more STAs and used for Automatic Gain Control (AGC) settings. After that, a Legacy Long Training Field (L-LTF) 604 may be received. The reception of L-LTF 604 may ensure that a Legacy Signal field (L-SIG) 606 following the L-LTF 604 may be decoded. The received L-SIG field 606 may provide duration in symbols of the transmitted frame 600.

Following the L-SIG field 606, a Very High Throughput Signal field type A (i.e., VHT-SIGA field) 608 may be received. This field may provide necessary bits to inform the user STA about a number of dedicated spatial streams and about a MCS for data in the case of Single-User (SU) transmission. In an embodiment, this field may also contain a tCRC, as described herein.

Following a Very High Throughput Short Training Field (VHT-STF) 610 and Very High Throughput Long Training Fields (VHT-LIFsₓ) 612a-c that may be utilized for channel estimation, the STAs may also receive a VHT-SIGB field (Very High Throughput Signal field type B) 614 associated with Multi-User Multiple-Input Multiple-Output (MU-MIMO) transmissions. This field may be used to provide MCS and possibly length information to each destination STA separately. Data 616a-c may follow the VHT-SIGB field 614, as illustrated in FIG. 6. In an embodiment, VHT-SIGB field 614 may contain a tCRC, as described herein. As an example, the VHT-SIGB field 614 may contain the tCRC if the VHT-SIGA field 608 does not contain the tCRC, and vice versa.

A destination STA may stop a decoding process if it fails to correctly decode at least one of the VHT-SIGA field 608 and/or the VHT-SIGB field 614. It should be noted that if a tCRC sum of these fields does not pass, then the receiving STA may not be able to determine an MCS and a spatial stream index for received data. Therefore, by forcing the tCRC error at some or all receiver STAs that are not intended destinations, it may be possible to ensure that STAs do not waste power for decoding the packet that is not intended for them.

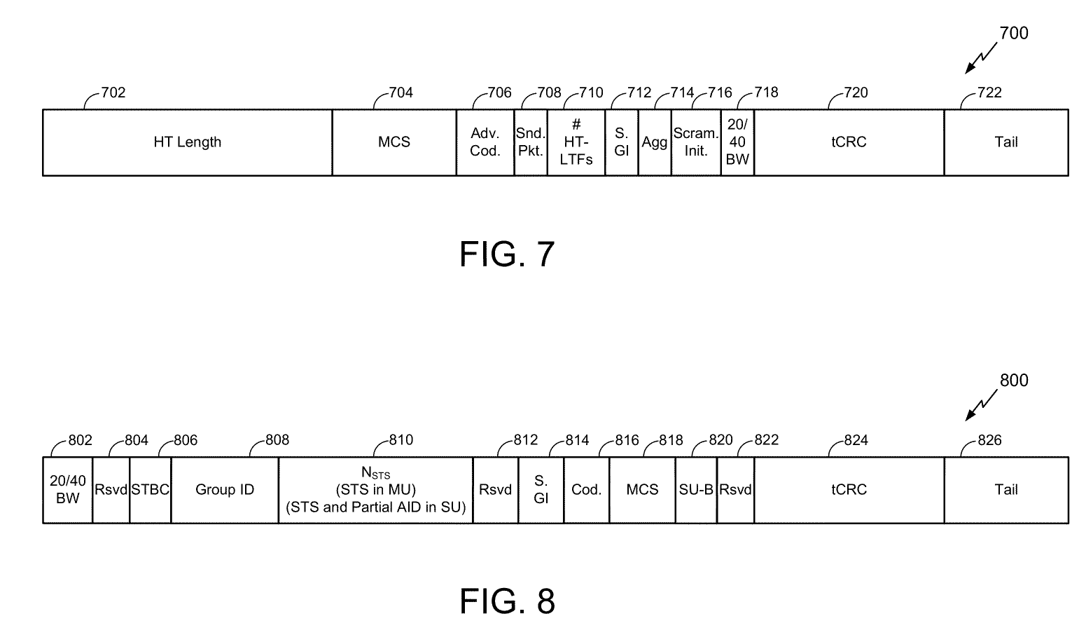

FIG. 7 illustrates an example structure of an HT-SIG field 700 in accordance with certain aspects of the present disclosure. The HT-SIG field 700 may be, for example, the HT-SIG field 508 illustrated in FIG. 5.

In WLANs, the process of decoding a field (e.g., the HT-SIG field 700) may comprise several steps. A High Throughput Length Field (HT Length) 702 of the HT-SIG field 700 may be first received to indicate a number of bytes in the payload. After that, an MCS field 704 may be received. The MCS field 704 may select the modulation and coding scheme and the number of spatial streams. Following the MCS field 704, an Advanced Coding field 706 may be received, which indicates whether the optional advanced coding is used. Following the Advanced Coding field 706, a Sounding Packet field 708 may be received. The Sounding Packet field 708 may indicate whether each antenna is transmitting its own spatial stream. After this field, a Number of HT-LTFs field 710 may be received, which indicates the number of HT-LTFs that may follow the HT-SIG field 700 in the frame.

Following the Number of HT-LTFs field 710, a Short GI field 712 may be received. The Short GI field 712 may indicate that a short guard interval is used on MIMO symbols in the Data field of the frame. After this field, an Aggregation field 714 may be received. The Aggregation field 714 may indicate whether the frame carries several MAC frames in an aggregate burst. Following the Aggregation field 714, a Scrambler Initialization field 716 may be received. This field may be used to seed a scrambler. After this field, a 20/40 Bandwidth (20/40 BW) field 718 may be received. The 20/40 BW field 718 may indicate a frequency of a channel.

Following the 20/40 BW field 718, a tCRC field 720 may be received. The tCRC field may contain a tCRC as described herein. The tCRC may be a typified CRC of the previously received fields. Following the tCRC field 720, a Tail field 722 may be received.

FIG. 8 illustrates an example structure of a VHT-SIGA field 800 in accordance with certain aspects of the present disclosure. The VHT-SIGA field 800 may be, for example, the VHT-SIGA field 608 illustrated in FIG. 6.

Fields as illustrated in FIG. 8 may be received in order, from left to right. In an embodiment, 20/40 BW field 802 may be similar to 20/40 BW field 718 as illustrated in FIG. 7, Short GI field 814 may be similar to Short GI field 712, Coding field 816 may be similar to Advanced Coding field 706, MCS field 818 may be similar to MCS field 704, tCRC field 824 may be similar to tCRC field 720, and Tail field 826 may be similar to Tail field 722. tCRC 824 may contain a tCRC as described herein. The tCRC may be a typified CRC of the previously received fields.

Reserved field 804 may be received following 20/40 BW field 802. This field may be reserved for later use. Following the Reserved field 804, a Space Time Blocking Code (STBC) field 806 may be received. The STBC field 806 may indicate whether all streams use a space time blocking code. After this field, a Group ID field 808 may be received. This field may indicate a single user transmission, a transmission where the group membership has not yet been established, and/or a transmission that needs to bypass a group. Following the Group ID field 808, a Space Time Stream field (N_{STS}) 810 may be received. In a multi-user (MU) transmission, this field may indicate a number of space time streams. In a SU transmission, this field may indicate a number of space time streams and/or contain a partial AID. In an embodiment, in a MU transmission, the bits allocated to a partial AID for use in a SU transmission may be set to zero. As is described herein, in a MU transmission, because the partial AID bits are set to zero, CDs may reuse the bits allocated to the partial AID. After the N_{STS} field 810, a Reserved field 812 may be received, where the Reserved field 812 may be reserved for later use.

Following the MCS field 818, a SU-Beamformed field (SU-B) 820 may be received. This field may indicate when a packet is a SU-beamformed packet. After the SU-B field 820, a Reserved field 822 may be received.

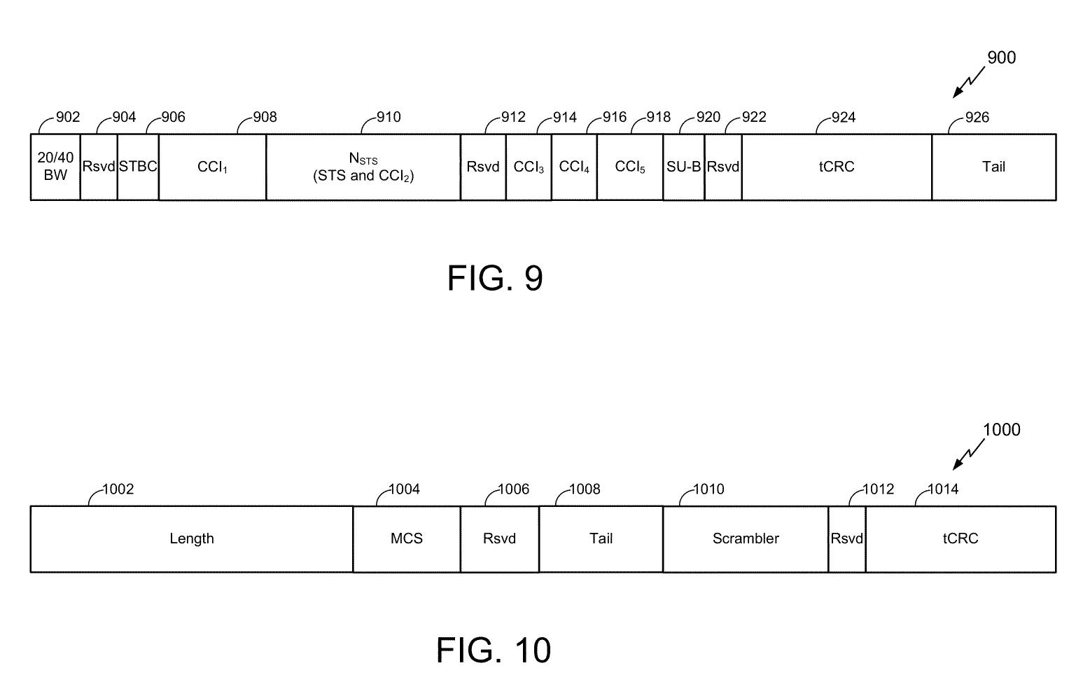

FIG. 9 illustrates an example structure of a VHT-SIGA field 900 in accordance with certain aspects of the present disclosure. The VHT-SIGA field 900 may be, for example, the VHT-SIGA field 608 illustrated in FIG. 6.

In an embodiment, VHT-SIGA field 900 may contain one or more CCIs if the frame is intended for multicast and/or broadcast transmission. For example, CCI field 908 may reuse the bits of Group ID field 808 illustrated in FIG. 8 to achieve more granular low power filtering. Likewise, N_{STS} field 910 may contain CCI bits in place of a partial AID, as described herein. CCI field 914 may reuse the bits of Short GI field 814, CCI field 916 may reuse the bits of Coding field 816, and CCI field 918 may reuse the bits of MCS field 818 to achieve more granular low power filtering. In some implementations, one or more of the CCI fields may overlap to form one or more CCIs. In some configurations, the VHT-SIGA field 900 may include one or more of a 20/40 BW field 902, one or more Reserved fields 904, 912, 922, an STBC field 906, an SU-B field 920 and a tCRC field 924, which may be similar to like-named fields described herein.

FIG. 10 illustrates an example structure of a VHT-SIGB field 1000 in accordance with certain aspects of the present disclosure. The VHT-SIGB field 1000 may be, for example, the VHT-SIGB field 614 illustrated in FIG. 6.

In WLANs, the process of decoding a field (e.g., the VHT-SIGB field 1000) may comprise several steps. A Length field 1002 of the VHT-SIGB field 1000 may be first received to indicate a length of useful data in the physical layer service data unit (PSDU). After that, an MCS field 1004 may be received. MCS field 1004 may be similar to other MCS fields as described herein.

Following the MCS field 1004, a Reserved field 1006 may be received, which may contain bits reserved for later use. After the Reserved field 1006, a Tail field 1008 may be received. Following the Tail field 1008, a Scrambler Seed field 1010 may be received. After the Scrambler Seed field 1010, a Reserved field 1012 may be received, which may contain bits reserved for later use. Following the Reserved field 1012, a tCRC field 1014 may be received. In an embodiment, the tCRC field may contain a typified CRC of the previously received fields in the frame and/or of the previously received fields in the VHT-SIGB field 1000. In another embodiment, the tCRC field may contain a typified CRC of the previously received fields in the VHT-SIGB field 1000 except for the Scrambler Seed field 1010.

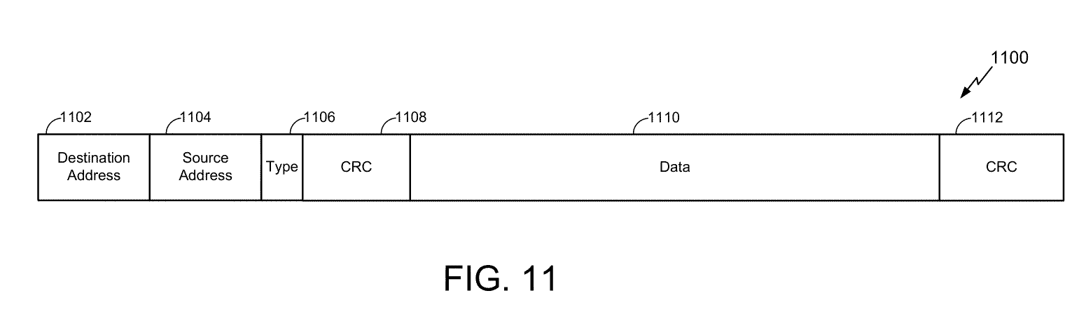

FIG. 11 illustrates an example structure of a MAC layer 1100 in accordance with certain aspects of the present disclosure. The MAC layer 1100 may, for example, follow the HT-LTFs field 512a-c illustrated in FIG. 5 and/or the VHT-SIGB field 614 illustrated in FIG. 6.

In WLANs, the process of decoding a layer (e.g., the MAC layer 1100) may comprise several steps. For example, the MAC header may be decoded before the data is decoded. In an embodiment, the MAC header comprises a Destination Address field 1102, a Source Address field 1104, and a Type field 1106. A CRC field 1108 may follow the MAC header. In some implementations, the CRC field 1108 may contain a CRC of the MAC header computed using any known method. In this way, if a decoder, such as decoder 406 as illustrated in FIG. 4, descrambles the CRC contained in CRC field 1108 and the CRC check does not pass, a STA may be able to determine whether the packet is of a unicast, broadcast, or multicast frame type and whether it is the intended recipient of the packet. Decoding the data in Data field 1110 may not be necessary to filter the packet. Note that CRC field 1112 may be just a CRC of data in Data field 1110.

Note that the frames and fields illustrated in FIGS. 5-11 and described herein are merely exemplary structures and aspects of the present disclosure may be implemented in other frames and/or fields not shown.

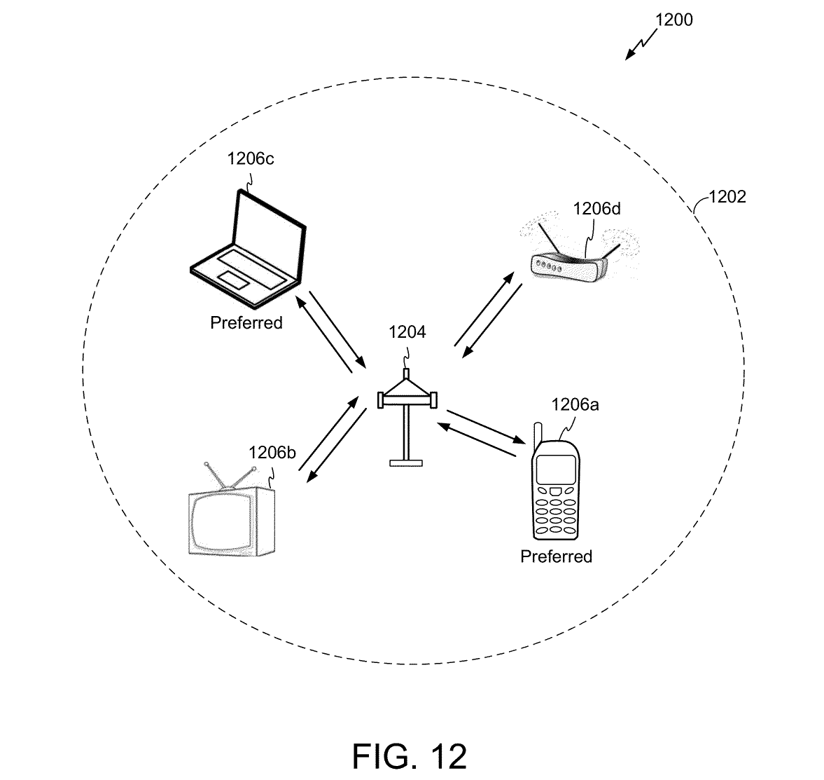

FIG. 12 shows an exemplary wireless communication system. In an embodiment, the wireless communication system 1200 may be similar to wireless communication system 100 as illustrated in FIG. 1. The wireless communication system 1200 may include an AP 1204, which communicates with STAs such as a mobile phone 1206a, a television 1206b, a computer 1206c, or another access point 1206d. For simplicity, only one AP 1204 is shown in FIG. 12.

In some implementations, a number of STAs may outnumber a number of available unique S-TIDs. For example, in a wireless communication system employing the IEEE 802.11ah protocol, nearly 6000 STAs 1206 may be associated with the AP 1204. In order to assign a unique S-TID to each STA, at least a 13 bit CRC may be desired to achieve the power savings as described herein. In an embodiment, no S-TIDs may be assigned to any STA 1206 and instead all available x-TIDs may be F-TIDs. For example, the F-TIDs may be used for frame-type filtering and/or IE-change filtering as described herein.

In another embodiment, the mobile phone 1206a, the computer 1206c, and/or other STAs (not shown) may be considered preferred STAs. S-TIDs may be assigned to only preferred STAs. Preferred STAs may be those STAs in which power consumption is a concern. Any remaining x-TIDs may be F-TIDs. For example, preferred STAs may be assigned S-TIDs and the remaining F-TIDs may be used for frame-type filtering and/or IE-change filtering as described herein.

In another embodiment, if a number of CRC bits is small (e.g., 4 bits), no S-TIDs may be assigned to any STA and all available x-TIDs may be F-TIDs used for IE-change filtering as described herein. For example, a subset of IEs (e.g., IEs that are of particular concern to STAs 1206 and/or the AP 1204 or IEs that are generally filtered) may be assigned IEIDs.

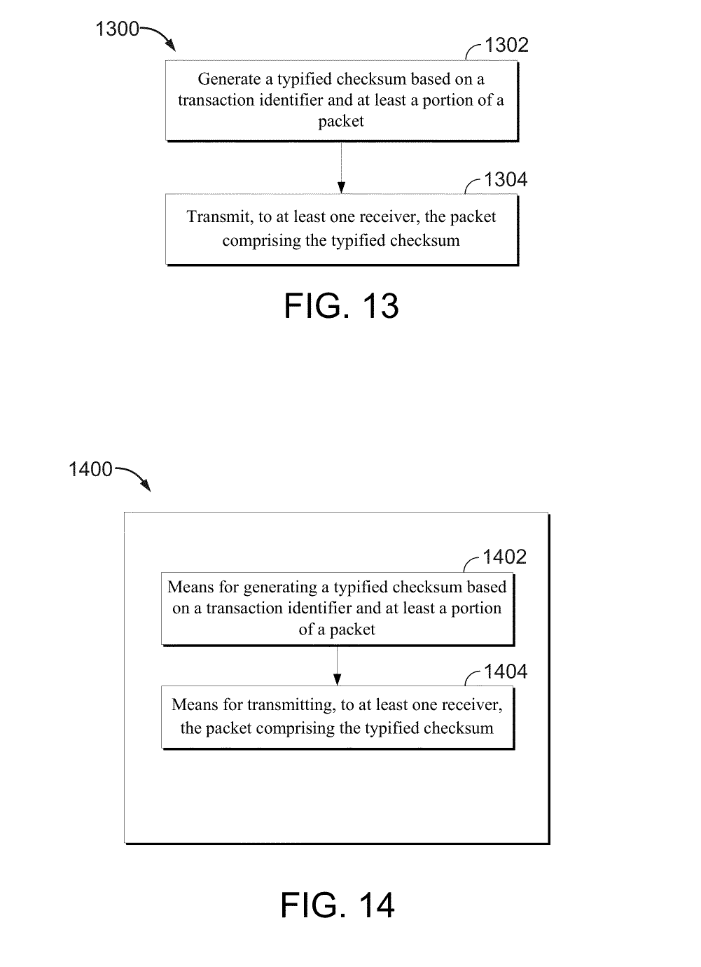

FIG. 13 is a flowchart of an exemplary method 1300 for enabling low power frame filtering. Although the method of flowchart 1300 is described herein with reference to the wireless device 200 discussed above with respect to FIG. 2, a person having ordinary skill in the art will appreciate that the method of flowchart 1300 may be implemented by the encoder 402 discussed above with respect to FIG. 4, the processor unit(s) 410 discussed above with respect to FIG. 4, and/or any other suitable device. In an embodiment, the steps in flowchart 1300 may be performed by a processor or controller in conjunction with one or more of the low power communication processor 400, the transmitter 210, and the processor unit(s) 204. Although the method of flowchart 1300 is described herein with reference to a particular order, in various embodiments, blocks herein may be performed in a different order, or omitted, and additional blocks may be added.

The low power communication processor may generate 1302 a typified checksum based on a transaction identifier and at least a portion of a packet. In an embodiment, the transaction identifier may be an S-TID and/or an F-TID. The transmitter may transmit 1304, to at least one receiver, the packet comprising the typified checksum. In an embodiment, bits of the typified checksum are located in a physical link layer of the packet.

FIG. 14 is a functional block diagram of a wireless device 1400, in accordance with an exemplary embodiment of the invention. The wireless device 1400 includes means 1402 for generating a typified checksum based on a transaction identifier and at least a portion of a packet. In an embodiment, means 1402 for generating a typified checksum based on a transaction identifier and at least a portion of a packet may be configured to perform one or more of the functions discussed above with respect to the block 1302. The wireless device 1400 further includes means 1404 for transmitting, to at least one receiver, the packet comprising the typified checksum. In an embodiment, means 1404 for transmitting, to at least one receiver, the packet comprising the typified checksum may be configured to perform one or more of the functions discussed above with respect to the block 1304.

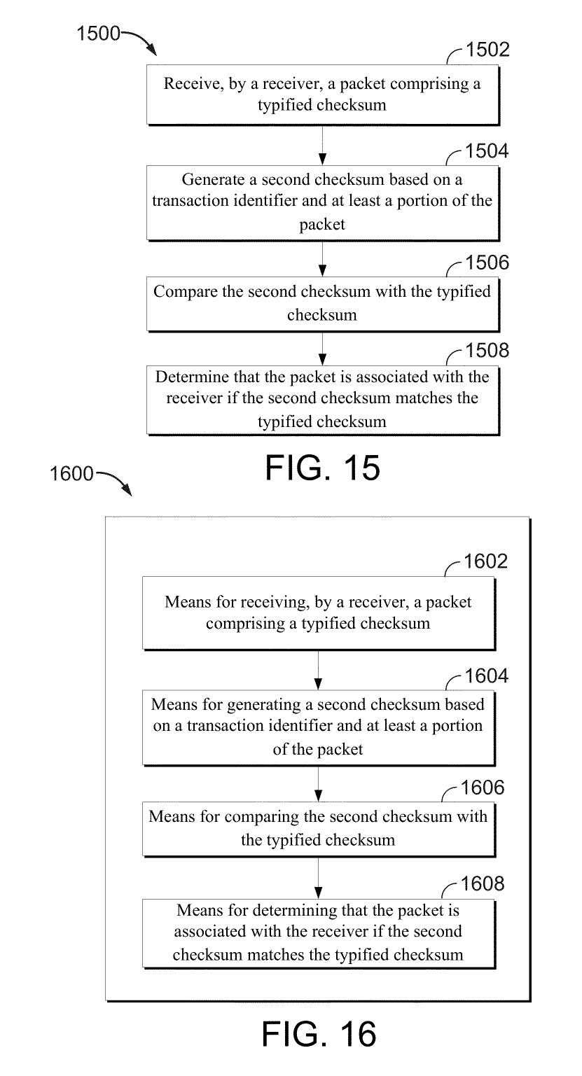

FIG. 15 is a flowchart of an exemplary method 1500 for low power frame filtering. Although the method of flowchart 1500 is described herein with reference to the wireless device 200 discussed above with respect to FIG. 2, a person having ordinary skill in the art will appreciate that the method of flowchart 1500 may be implemented by the decoder 406 discussed above with respect to FIG. 4, the processor unit(s) 410 discussed above with respect to FIG. 4, and/or any other suitable device. In an embodiment, the steps in flowchart 1500 may be performed by a processor or controller in conjunction with one or more of the low power communication processor 400, the receiver 212, and the processor unit(s) 204. Although the method of flowchart 1500 is described herein with reference to a particular order, in various embodiments, blocks herein may be performed in a different order, or omitted, and additional blocks may be added.

The receiver may receive 1502 a packet comprising a typified checksum. In an embodiment, the typified checksum may be based on an S-TID and/or an F-TID. The low power communication processor may generate 1504 a second checksum based on a transaction identifier and at least a portion of the packet. In an embodiment, the second checksum may be based on an S-TID and/or an F-TID and a PPDU of a packet.

The low power communication processor may compare 1506 the second checksum with the typified checksum. The low power communication processor may determine 1508 that the packet is associated with the receiver if the second checksum matches the typified checksum. In an embodiment, the packet may be filtered if it is determined 1508 that the packet is not associated with the receiver.

FIG. 16 is a functional block diagram of a wireless device 1600, in accordance with an exemplary embodiment of the invention. The wireless device 1600 includes means 1602 for receiving, by a receiver, a packet comprising a typified checksum. In an embodiment, means 1602 for receiving, by a receiver, a packet comprising a typified checksum may be configured to perform one or more of the functions discussed above with respect to the block 1502. The wireless device 1600 further includes means 1604 for generating a second checksum based on a transaction identifier and at least a portion of the packet. In an embodiment, means 1604 for generating a second checksum based on a transaction identifier and at least a portion of the packet may be configured to perform one or more of the functions discussed above with respect to the block 1504. The wireless device 1600 further includes means 1606 for comparing the second checksum with the typified checksum. In an embodiment, means 1606 for comparing the second checksum with the typified checksum may be configured to perform one or more of the functions discussed above with respect to the block 1506. The wireless device 1600 further includes means 1608 for determining that the packet is associated with the receiver if the second checksum matches the typified checksum. In an embodiment, means 1608 for determining that the packet is associated with the receiver if the second checksum matches the typified checksum may be configured to perform one or more of the functions discussed above with respect to the block 1508.

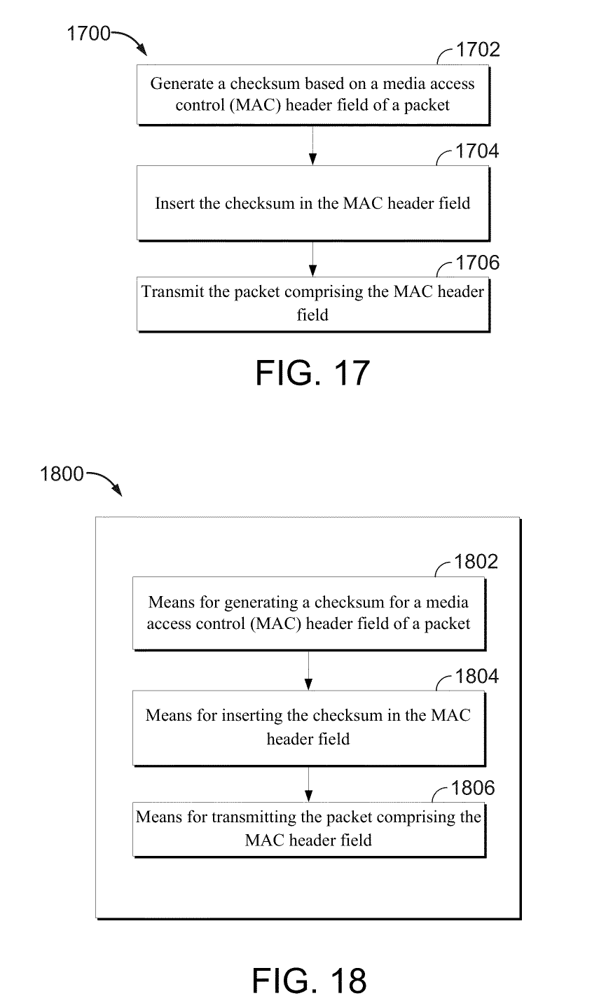

FIG. 17 is a flowchart of an exemplary method 1700 for enabling low power frame filtering. Although the method of flowchart 1700 is described herein with reference to the wireless device 200 discussed above with respect to FIG. 2, a person having ordinary skill in the art will appreciate that the method of flowchart 1700 may be implemented by the encoder 402 discussed above with respect to FIG. 4, the processor unit(s) 410 discussed above with respect to FIG. 4, and/or any other suitable device. In an embodiment, the steps in flowchart 1700 may be performed by a processor or controller in conjunction with one or more of the low power communication processor 400, the transmitter 210, and the processor unit(s) 204. Although the method of flowchart 1700 is described herein with reference to a particular order, in various embodiments, blocks herein may be performed in a different order, or omitted, and additional blocks may be added.

The low power communication processor may generate 1702 a checksum based on a media access control (MAC) header field of a packet. In an embodiment, the checksum may be a typified checksum as described herein. The low power communication processor may insert 1704 the checksum in the MAC header field. In an embodiment, the checksum may be inserted 1704 after a preamble of the MAC header field. The transmitter may transmit 1706 the packet comprising the MAC header field.

FIG. 18 is a functional block diagram of a wireless device 1800, in accordance with an exemplary embodiment of the invention. The wireless device 1800 includes means 1802 for generating a checksum based on a media access control (MAC) header field of a packet. In an embodiment, means 1802 for generating a checksum based on a media access control (MAC) header field of a packet may be configured to perform one or more of the functions discussed above with respect to the block 1702. The wireless device 1800 further includes means 1804 for inserting the checksum in the MAC header field. In an embodiment, means 1804 for inserting the checksum in the MAC header field may be configured to perform one or more of the functions discussed above with respect to the block 1704. The wireless device 1800 further includes means 1806 for transmitting the packet comprising the MAC header field. In an embodiment, means 1806 for transmitting the packet comprising the MAC header field may be configured to perform one or more of the functions discussed above with respect to the block 1706.

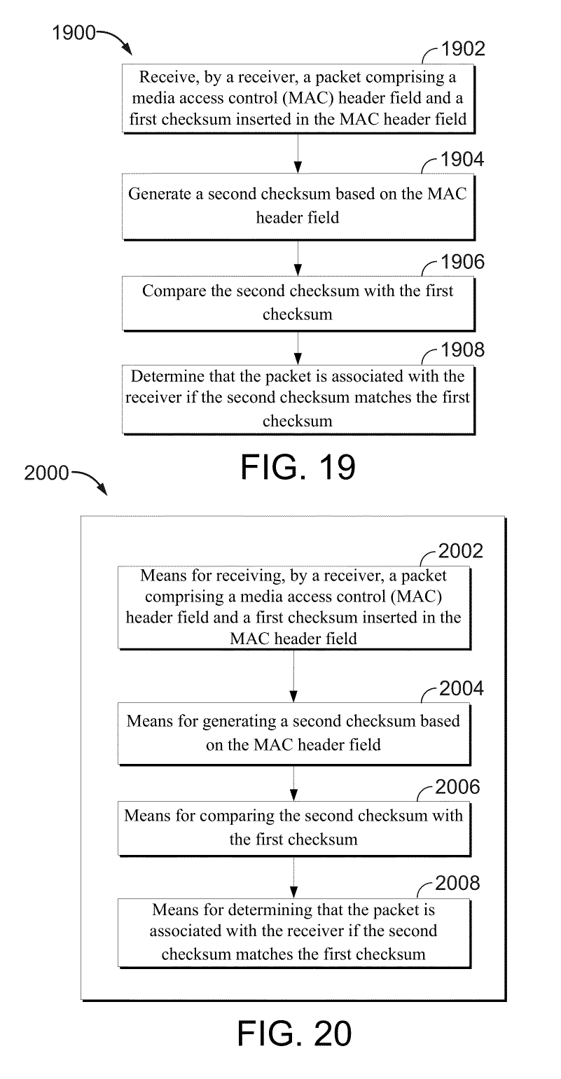

FIG. 19 is a flowchart of an exemplary method 1900 for low power frame filtering. Although the method of flowchart 1900 is described herein with reference to the wireless device 200 discussed above with respect to FIG. 2, a person having ordinary skill in the art will appreciate that the method of flowchart 1900 may be implemented by the decoder 406 discussed above with respect to FIG. 4, the processor unit(s) 410 discussed above with respect to FIG. 4, and/or any other suitable device. In an embodiment, the steps in flowchart 1900 may be performed by a processor or controller in conjunction with one or more of the low power communication processor 400, the receiver 212, and the processor unit(s) 204. Although the method of flowchart 1900 is described herein with reference to a particular order, in various embodiments, blocks herein may be performed in a different order, or omitted, and additional blocks may be added.

The receiver may receive 1902 a packet comprising a media access control (MAC) header field and a first checksum inserted in the MAC header field. In an embodiment, the first checksum may be a typified checksum. In an embodiment, the first checksum may be inserted after a preamble of the MAC header field. The low power communication processor may generate 1904 a second checksum based on the MAC header field.

The low power communication processor may compare 1906 the second checksum with the first checksum. The low power communication processor may determine 1908 that the packet is associated with the receiver if the second checksum matches the first checksum. In an embodiment, the packet may be filtered if it is determined 1908 that the packet is not associated with the receiver.

FIG. 20 is a functional block diagram of a wireless device 2000, in accordance with an exemplary embodiment of the invention. The wireless device 2000 includes means 2002 for receiving, by a receiver, a packet comprising a media access control (MAC) header field and a first checksum inserted in the MAC header field. In an embodiment, means 2002 for receiving, by a receiver, a packet comprising a media access control (MAC) header field and a first checksum inserted in the MAC header field may be configured to perform one or more of the functions discussed above with respect to the block 1902. The wireless device 2000 further includes means 2004 for generating a second checksum based on the MAC header field. In an embodiment, means 2004 for generating a second checksum based on the MAC header field may be configured to perform one or more of the functions discussed above with respect to the block 1904. The wireless device 2000 further includes means 2006 for comparing the second checksum with the first checksum. In an embodiment, means 2006 for comparing the second checksum with the first checksum may be configured to perform one or more of the functions discussed above with respect to the block 1906. The wireless device 2000 further includes means 2008 for determining that the packet is associated with the receiver if the second checksum matches the first checksum. In an embodiment, means 2008 for determining that the packet is associated with the receiver if the second checksum matches the first checksum may be configured to perform one or more of the functions discussed above with respect to the block 1908.

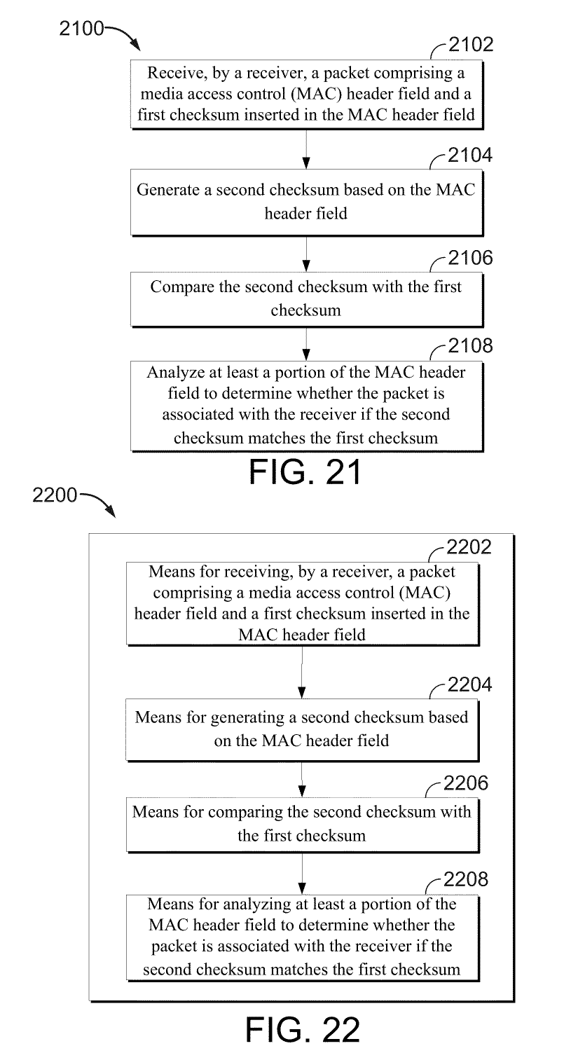

FIG. 21 is a flowchart of an exemplary method 2100 for low power frame filtering. Although the method of flowchart 2100 is described herein with reference to the wireless device 200 discussed above with respect to FIG. 2, a person having ordinary skill in the art will appreciate that the method of flowchart 2100 may be implemented by the decoder 406 discussed above with respect to FIG. 4, the processor unit(s) 410 discussed above with respect to FIG. 4, and/or any other suitable device. In an embodiment, the steps in flowchart 2100 may be performed by a processor or controller in conjunction with one or more of the low power communication processor 400, the receiver 212, and the processor unit(s) 204. Although the method of flowchart 2100 is described herein with reference to a particular order, in various embodiments, blocks herein may be performed in a different order, or omitted, and additional blocks may be added.

The receiver may receive 2102 a packet comprising a media access control (MAC) header field and a first checksum inserted in the MAC header field. In an embodiment, the first checksum may be inserted after a preamble of the MAC header field. The low power communication processor may generate 2104 a second checksum based on the MAC header field.

The low power communication processor may compare 2106 the second checksum with the first checksum. The low power communication processor may analyze 2108 at least a portion of the MAC header field to determine whether the packet is associated with the receiver if the second checksum matches the first checksum. In an embodiment, the packet may be filtered if at least a portion of the MAC header field does not match an address of the receiver.

FIG. 22 is a functional block diagram of a wireless device 2200, in accordance with an exemplary embodiment of the invention. The wireless device 2200 includes means 2202 for receiving, by a receiver, a packet comprising a media access control (MAC) header field and a first checksum inserted in the MAC header field. In an embodiment, means 2202 for receiving, by a receiver, a packet comprising a media access control (MAC) header field and a first checksum inserted in the MAC header field may be configured to perform one or more of the functions discussed above with respect to the block 2102. The wireless device 2200 further includes means 2204 for generating a second checksum based on the MAC header field. In an embodiment, means 2204 for generating a second checksum based on the MAC header field may be configured to perform one or more of the functions discussed above with respect to the block 2104. The wireless device 2200 further includes means 2206 for comparing the second checksum with the first checksum. In an embodiment, means 2206 for comparing the second checksum with the first checksum may be configured to perform one or more of the functions discussed above with respect to the block 2106. The wireless device 2200 further includes means 2208 for analyzing at least a portion of the MAC header field to determine whether the packet is associated with the receiver if the second checksum matches the first checksum. In an embodiment, means 2208 for analyzing at least a portion of the MAC header field to determine whether the packet is associated with the receiver if the second checksum matches the first checksum may be configured to perform one or more of the functions discussed above with respect to the block 2108.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-Ray® disc where disks usually reproduce data magnetically, while discs reproduce data optically with lasers.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method for enabling low power frame filtering, the method comprising:
generating a typified checksum based on a transaction identifier and at least a portion of a packet;
inserting bits of the typified checksum in a physical layer of the packet; and
transmitting, to at least one receiver, the packet comprising the typified checksum.

2. The method of claim 1, wherein generating a typified checksum comprises generating a typified checksum based on a station transaction identifier associated with the at least one receiver.

3. The method of claim 2, wherein transmitting the packet comprises transmitting the packet in a directed transmission mode.

4. The method of claim 1, wherein generating a typified checksum comprises generating a typified checksum based on at least one frame transaction identifier associated with a type of transmission mode or an information element.

5. The method of claim 4, further comprising generating a content change indicator, wherein the content change indicator provides the at least one receiver with information on whether the packet should be filtered, and wherein bits of the content change indicator are located in a physical layer of the packet.

6. The method of claim 5, wherein bits of the content change indicator are located in a portion of the packet originally allocated for a partial association identification.

7. The method of claim 5, wherein bits of the content change indicator are located in at least one field of a physical layer of the packet that is irrelevant in a multicast or broadcast transmission mode.

8. The method of claim 1, wherein generating a typified checksum comprises generating a typified checksum based on a transaction identifier that is either associated with the at least one receiver or is associated with a type of transmission mode based on whether the at least one receiver receives packets in a directed transmission mode or a non-directed transmission mode.

9. The method of claim 1, further comprising inserting bits of a first signal field in a physical layer of the packet.

10. The method of claim 1, wherein generating the typified checksum further comprises performing an exclusive or (XOR) operation between at least one bit of a first signal field and at least one bit of the transaction identifier.

11. An apparatus configured to enable low power frame filtering, the apparatus comprising:
means for generating a typified checksum based on a transaction identifier and at least a portion of a packet;
means for inserting bits of the typified checksum in a physical layer of the packet; and
means for transmitting, to at least one receiver, the packet comprising the typified checksum.

12. The apparatus of claim 11, wherein means for generating a typified checksum comprises means for generating a typified checksum based on a station transaction identifier associated with the at least one receiver.

13. The apparatus of claim 11, wherein means for generating a typified checksum comprises means for generating a typified checksum based on at least one frame transaction identifier associated with a type of transmission mode or an information element.

14. The apparatus of claim 11, wherein means for generating a typified checksum comprises means for generating a typified checksum based on a transaction identifier that is either associated with the at least one receiver or is associated with a type of transmission mode based on whether the at least one receiver receives packets in a directed transmission mode or a non-directed transmission mode.

15. The apparatus of claim 11, further comprising means for inserting bits of a first signal field in a physical layer of the packet.

16. The apparatus of claim 11, wherein means for generating the typified checksum further comprises means for performing an exclusive or (XOR) operation between at least one bit of a first signal field and at least one bit of the transaction identifier.

17. A non-transitory computer-readable medium comprising code that, when executed, causes an apparatus to:
generate a typified checksum based on a transaction identifier and at least a portion of a packet;
insert bits of the typified checksum in a physical layer of the packet; and
transmit, to at least one receiver, the packet comprising the typified checksum.

18. The medium of claim 17, further comprising code that, when executed, causes the apparatus to generate a typified checksum based on a station transaction identifier associated with the at least one receiver.

19. The medium of claim 17, further comprising code that, when executed, causes the apparatus to generate a typified checksum based on at least one frame transaction identifier associated with a type of transmission mode or an information element.

20. The medium of claim 17, further comprising code that, when executed, causes the apparatus to generate a typified checksum based on a transaction identifier that is either associated with the at least one receiver or is associated with a type of transmission mode based on whether the at least one receiver receives packets in a directed transmission mode or a non-directed transmission mode.

21. The medium of claim 17, further comprising code that, when executed, causes the apparatus to insert bits of a first signal field in a physical layer of the packet.

22. The medium of claim 17, further comprising code that, when executed, causes the apparatus to perform an exclusive or (XOR) operation between at least one bit of a first signal field and at least one bit of the transaction identifier.

23. An access point configured to enable low power frame filtering, comprising:
at least one antenna;
a first circuit configured to generate a typified checksum based on a transaction identifier and at least a portion of a packet, wherein bits of the typified checksum are located in a physical layer of the packet; and
a transmitter configured to transmit, to at least one receiver via the at least one antenna, the packet comprising the typified checksum.

24. The access point of claim 23, wherein the transaction identifier is a station transaction identifier associated with the at least one receiver.

25. The access point of claim 24, wherein the at least one receiver communicates with the transmitter in a directed transmission mode.

26. The access point of claim 23, wherein the transaction identifier comprises at least one frame transaction identifier associated with a type of transmission mode or an information element.

27. The access point of claim 26, further comprising a third circuit configured to generate a content change indicator, wherein the content change indicator provides the at least one receiver with information on whether the packet should be filtered, and wherein bits of the content change indicator are located in a physical layer of the packet.

28. The access point of claim 27, wherein bits of the content change indicator are located in a portion of the packet originally allocated for a partial association identification.

29. The access point of claim 27, wherein bits of the content change indicator are located in at least one field of a physical layer of the packet that is irrelevant in a multicast or broadcast transmission mode.

30. The access point of claim 23, wherein the transaction identifier is either associated with the at least one receiver or is associated with a type of transmission mode based on whether the at least one receiver receives packets in a directed transmission mode or a non-directed transmission mode.

31. The access point of claim 23, wherein bits of a first signal field are located in a physical layer of the packet.

32. The access point of claim 23, wherein the first circuit is further configured to perform an exclusive or (XOR) operation between at least one bit of a first signal field and at least one bit of the transaction identifier.

33. A method for low power frame filtering, the method comprising:
receiving, by a receiver, a packet comprising a typified checksum;
generating a second checksum based on a transaction identifier and at least a portion of the packet;
comparing the second checksum with the typified checksum; and
determining that the packet is associated with the receiver if the second checksum matches the typified checksum.

34. The method of claim 33, wherein generating a second checksum comprises generating a second checksum based on a station transaction identifier associated with the receiver.

35. The method of claim 33, wherein generating a second checksum comprises generating a second checksum based on at least one frame transaction identifier associated with a type of transmission mode or an information element.

36. The method of claim 33, wherein generating a second checksum comprises generating a second checksum based on a transaction identifier that is either associated with the receiver or is associated with a type of transmission mode based on whether the receiver receives packets in a directed transmission mode or a non-directed transmission mode.

37. The method of claim 33, wherein determining that the packet is associated with the receiver further comprises determining that the packet is associated with the receiver based only on decoding a physical layer of the packet.

38. The method of claim 33, wherein generating the second checksum further comprises performing an exclusive or (XOR) operation between at least one bit of a first signal field and at least one bit of the transaction identifier.

39. An apparatus configured for low power frame filtering, the apparatus comprising:
means for receiving, by a receiver, a packet comprising a typified checksum;
means for generating a second checksum based on a transaction identifier and at least a portion of the packet;
means for comparing the second checksum with the typified checksum; and
means for determining that the packet is associated with the receiver if the second checksum matches the typified checksum.

40. The apparatus of claim 39, wherein means for generating a second checksum comprises means for generating a second checksum based on a station transaction identifier associated with the receiver.

41. The apparatus of claim 39, wherein means for determining that the packet is associated with the receiver further comprises means for determining that the packet is associated with the receiver based only on decoding a physical layer of the packet.

42. A non-transitory computer-readable medium comprising code that, when executed, causes an apparatus to:
receive, by a receiver, a packet comprising a typified checksum;
generate a second checksum based on a transaction identifier and at least a portion of the packet;
compare the second checksum with the typified checksum; and
determine that the packet is associated with the receiver if the second checksum matches the typified checksum.

43. The medium of claim 42, further comprising code that, when executed, causes the apparatus to generate a second checksum based on a station transaction identifier associated with the receiver.

44. The medium of claim 42, further comprising code that, when executed, causes the apparatus to determine that the packet is associated with the receiver based only on decoding a physical layer of the packet.

45. An apparatus configured for low power frame filtering, the apparatus comprising:
a receiver configured to receive a packet comprising a typified checksum;
a first circuit configured to generate a second checksum based on a transaction identifier and at least a portion of the packet; and
a second circuit configured to compare the second checksum with the typified checksum and to determine that the packet is associated with the receiver if the second checksum matches the typified checksum.

46. The apparatus of claim 45, wherein the transaction identifier is a station transaction identifier associated with the receiver.

47. The apparatus of claim 45, wherein the transaction identifier comprises at least one frame transaction identifier associated with a type of transmission mode or an information element.

48. The apparatus of claim 45, wherein the transaction identifier is either associated with the receiver or is associated with a type of transmission mode based on whether the receiver receives packets in a directed transmission mode or a non-directed transmission mode.

49. The apparatus of claim 45, wherein the second circuit is further configured to determine that the packet is associated with the receiver based only on decoding a physical layer of the packet.

50. The apparatus of claim 45, wherein the first circuit is further configured to perform an exclusive or (XOR) operation between at least one bit of a first signal field and at least one bit of the transaction identifier.

51. A method for enabling low power frame filtering, the method comprising:
generating a checksum based on a media access control (MAC) header field of a packet;
inserting the checksum in the MAC header field; and
transmitting the packet comprising the MAC header field.

52. An apparatus configured to enable low power frame filtering, the apparatus comprising:
means for generating a checksum based on a media access control (MAC) header field of a packet;
means for inserting the checksum in the MAC header field; and
means for transmitting the packet comprising the MAC header field.

53. A non-transitory computer-readable medium comprising code that, when executed, causes an apparatus to:
generate a checksum based on a media access control (MAC) header field of a packet;
insert the checksum in the MAC header field; and
transmit the packet comprising the MAC header field.

54. An access point configured to enable low power frame filtering, comprising:
at least one antenna;
a first circuit configured to generate a checksum based on a media access control (MAC) header field of a packet and configured to insert the checksum in the MAC header field; and
a transmitter configured to transmit the packet comprising the MAC header field.

55. A method for low power frame filtering, the method comprising:
receiving, by a receiver, a packet comprising a media access control (MAC) header field and a first checksum inserted in the MAC header field;
generating a second checksum based on the MAC header field;
comparing the second checksum with the first checksum; and
determining whether the packet is associated with the receiver based on whether the second checksum matches the first checksum.

56. The method of claim 55, further comprising filtering the packet if the second checksum does not match the first checksum.

57. An apparatus configured for low power frame filtering, the apparatus comprising:
means for receiving, by a receiver, a packet comprising a media access control (MAC) header field and a first checksum inserted in the MAC header field;
means for generating a second checksum based on the MAC header field;
means for comparing the second checksum with the first checksum; and
means for determining whether the packet is associated with the receiver based on whether the second checksum matches the first checksum.

58. A non-transitory computer-readable medium comprising code that, when executed, causes an apparatus to:
receive, by a receiver, a packet comprising a media access control (MAC) header field and a first checksum inserted in the MAC header field;
generate a second checksum based on the MAC header field;
compare the second checksum with the first checksum; and
determine whether the packet is associated with the receiver based on whether the second checksum matches the first checksum.

59. An apparatus configured for low power frame filtering, the apparatus comprising:
a receiver configured to receive a packet comprising a media access control (MAC) header field and a first checksum inserted in the MAC header field;
a first circuit configured to generate a second checksum based on the MAC header field; and
a second circuit configured to compare the second checksum with the first checksum, and configured to determine whether the packet is associated with the receiver based on whether the second checksum matches the first checksum.

60. The apparatus of claim 59, wherein the second circuit is further configured to filter the packet if the second checksum does not match the first checksum.
